(19) United States
(12) Patent Application Publication
(10) Pub. No.: US 2019/0371201 A1
(43) Pub. Date: Dec. 5, 2019

(54) READING DEVICE

(71) Applicant: Wolfgang Baum, Meckesheim (DE)

(72) Inventor: Wolfgang Baum, Meckesheim (DE)

(21) Appl. No.: 16/467,898

(22) PCT Filed: Dec. 4, 2017
(86) PCT No.: PCT/DE2017/200124

§ 371 Date: Jun. 7, 2019

(30) Foreign Application Priority Data
Dec. 8, 2016 (DE) 10 2016 224 444.2

(51) Int. Cl. G09B 21/00; H04N 1/04; H04N 1/00

(52) U.S. Cl. CPC G09B 21/003; G09B 21/007; H04N 2201/0434; H04N 1/00267; H04N 1/04

(57) ABSTRACT

A reading device, in particular for the visually impaired, has a flat and transparent platen for reading material and an image-recording device for acquiring through the platen a text and/or an image of at least a part of the reading material. The reading device is designed and further developed to provide for easy transportation and simple stowage of the reading device when not in use. A support element is pivotable relative to the platen about a pivot axis assigned to the platen. The support element is pivotable into an operating position inclined at a defined angle to a vertical direction to position the platen into an operating position. The support element is also pivotable into a transportation or rest position whereby the platen and the support element substantially lie against each other.

### BACKGROUND

### Technical Field

The present disclosure relates to a reading device, in particular for the visually impaired, having a flat and transparent platen for reading material and an image-recording device for acquiring through the platen a text and/or an image of at least a part of the reading material.

### Description of the Related Art

Reading devices of the aforementioned type are known in practice and exist in various embodiments. For example, reading devices are known in which the image-recording device has a scanner and the platen is formed by a glass plate.

Furthermore, reading devices are known in which the image-recording device has a camera that acquires an image of the reading material positioned on the platen.

Furthermore, a reading device is known from DE 10 2012 221 810 A1, wherein the transparent platen is realized by a glass plate inclined at an angle to a base element. In the case of the known reading device, reading material, for example a book, can be positioned on the platen in such a way that a perfect image acquisition of a text is possible even in the marginal areas and fold areas of a book or a periodical. In the known reading device, an image recording takes place through the platen by means of a camera arranged in the base element. The base element has a standing surface for securely positioning the reading device on a substrate, for example a table.

In the case of the known reading device, it is problematic that the device is ultimately designed in the sense of a surface-mounted device for a permanently defined installation and operating location. A change of the place of use requires a not inconsiderable effort for transportation and, where applicable, packing. Furthermore, the known reading device takes up a very considerable volume of space when not in use, this being disturbing in particular in a living area.

### BRIEF SUMMARY AND INITIAL DESCRIPTION

The present disclosure is therefore based on the object of designing and developing a reading device of the aforementioned type in such a way that a particularly simple transportation and a simple stowage of the reading device are made possible with structurally simple means when the reading device is not in use.

According to the disclosure, the above object is achieved by way of a reading device with the features of claim 1. Accordingly, the reading device is designed and developed in such a way that a support element that is pivotable relative to the platen about a pivot axis is assigned to the platen, wherein the support element can be pivoted into an operating position inclined at a defined angle to a vertical direction for the purpose of positioning the platen, and into a transportation or rest position whereby the platen and the support element substantially lie against each other.

In a manner according to the present disclosure, it was initially recognized that, by a clever arrangement of the platen, the above object is achieved in a surprisingly simple manner. In a further manner according to the disclosure, it was then recognized that, by realizing a support element which can be pivoted relative to the platen about a pivot axis, a design can be provided which ensures a particularly simple transportation and a simple stowage of the reading device when the reading device is not in use. Here, the support element can be pivoted into an operating position inclined at a defined angle to a vertical direction for the purpose of positioning the platen and—alternatively—into a transportation or rest position differing from the operating position and in which the platen and the support element substantially lie against or upon each other. In this case, the platen and the support element can, in the transportation or rest position, lie directly against each other, at least partially, or have a further component arranged between them. In the operating position, the pivoting of the support element relative to the platen leads to an arrangement in which the support element supports the platen in the inclined operating position. The inclined operating position thus offers the advantage that, for example, a book or a periodical can be placed on the platen such that a page of a book or periodical lies flat on the platen—even in the fold area. This substantially full contact of the reading material with the platen ensures a secure and complete acquisition of a text and/or an image of the reading material by the image-recording device by way of, for example, a camera. To achieve the transportation or rest position, the support element is then simply pivoted out of its pivot position supporting the platen in such a way that the platen and the support element substantially lie against each other. As a result, a shut arrangement of the platen and support element is realized. This arrangement ensures an easy transportation and a simple stowage of the reading device when not in use. In a simple case, this arrangement can, for example, be put into a bag and transported to any further place of use or, for example, be stowed on shelf or in a drawer.

The reading device according to the present disclosure thus, with structurally simple means, allows a particularly simple transportation and a simple stowage of the reading device when the reading device is not in use.

With respect to a development of a particularly simple design, the pivot axis can be realized in or on the platen, preferably in or on an edge region of the platen. In this embodiment, the support element and the platen are pivotally mounted on each other. In the operating position, the platen and the support element are pivoted at an angle to each other which allows the platen to be set up on a substrate, wherein the platen can hereby be positioned in an operating position inclined to a vertical direction. The transportation or rest position is achieved by pivoting the platen and the support element relative to each other, wherein the pivoting is continued until the platen and the support element substantially lie against or upon each other.

In order to realize a particularly stable embodiment of the reading device according to the disclosure, the support element or the platen can be pivotably articulated on a base element. Such an additional component in the form of the base element—additional to the support element and the platen—ensures an increase in the stability of the reading device both in the operating position and in the transportation or rest position. The base element can here serve as a base for the support element and the platen. In the transportation or rest position, the reading device can be shut in such a way that the support element, the platen, and the base element can lie against each other in a suitable sequence in order to provide a compact and flat arrangement which is simple to transport or stow. In this embodiment, the support element pivotably articulated on the base element or the platen pivotally articulated on the base element forms an intermediate component arranged between the base element and the platen or between the base element and the support element.

In an alternative advantageous embodiment, the pivot axis can be implemented in or on a base element. In this case, the support element can be pivoted in a suitable manner relative to the base element so as to support the platen in the operating position in a suitable manner. The base can in turn serve as a support for standing the reading device on a substrate.

The platen may take the form of a separate component that stands in a suitable manner on the base element—preferably in a groove or on a projection—and is supported in an inclined position by the support element. In a particularly advantageous manner and in order to realize a coupled arrangement in an assembly, the platen can also be pivotably mounted on the base element. To form the operating position, both the support element and the platen can be pivoted from a position in which they lie substantially against or upon each other relative to the base element in order to achieve the operating position of the platen supported by the support element. To realize the transportation or rest position, both the platen and the support element can be pivoted toward the base element, so that an arrangement of the base element, support element and platen is formed whereby they lie against or upon each other.

With regard to a particularly secure positioning of the platen in the operating position, the platen can have a contact area for the support element, wherein the contact area in a particularly advantageous manner can have a groove or a projection with which the support element can engage in the operating position.

In order to ensure a particularly reliable image acquisition, a preferably flat cover can be assigned to the platen. Such a cover can be placed on a reading material positioned on the platen in order on the one hand to position the reading material securely on the platen, and on the other hand to prevent or, at least as far as possible, reduce the transmission of light through reading material that is not opaque.

In a further advantageous manner, the cover can be pivotable relative to the platen. In this case, the cover can be pivotable on a base element of the reading device so that in the transportation or rest position the cover can likewise rest on the platen, the support element, or the base element. As a result, even in the case of the additional realization of a cover, a compact, folded-together or shut arrangement of the reading device can be realized.

In a specific embodiment, the reading device can have a processing device for processing the text and/or image acquired by way of the image-recording device. Such a processing device may take the form of a computing unit assigned to the support element or the base element or integrated into the support element or into the base element.

In a further embodiment, the reading device may have a display device for displaying the text and/or image processed by the processing device. Such a display device can advantageously be realized as a common component together with a cover. A particularly compact design of the reading device is thereby realized. A display device can, for example, be realized by a screen.

Alternatively or in addition to such a display device, the reading device can have a speech output device for the audio output of the text and/or image processed by the processing device and/or a refreshable Braille display for outputting as Braille the text and/or image processed by the processing device. Such a speech output device can be assigned to the processing device or be integrated into the processing device and, for example, have a speaker or an interface for connecting a speaker, such as a headset. By assigning a speech output device to the reading device or integrating a speech output device into the reading device, a reading-aloud device can be provided.

In another embodiment of the reading device according to the present disclosure, the image-recording device may have an interface for connecting a processing device for processing the text and/or image acquired by means of the image-recording device. Such an interface can provide a connection to a computer, for example a PC or laptop. Here, the processing device is realized by the computer, wherein the image-recording device, for example, a camera, can be supplied with power via the interface. With such a reading device, a mobile image-recording unit with a book edge or magazine edge is provided, which is suitable not only for the blind and visually impaired but also for any user of a computer device in the rest of the market.

Alternatively or additionally, the interface can be formed for connecting a display device for displaying the text and/or image processed by the processing device and/or for connecting a speech output device for the audio output of the text and/or image processed by the processing device and/or for connecting a refreshable Braille display for outputting as Braille the text and/or image processed by the processing device. In any case, a particularly mobile image-recording unit for connecting different functional units can be provided by a reading device of this type.

Depending on the individual requirement, the image-recording device can be assigned to the support element, the base element, or the processing device, or can preferably be integrally coupled to the support element, the base element, or the processing device. In the arrangement or assignment of the image-recording device, it is essential that in the operating position, this enables a reliable acquisition, through the platen, of a text and/or an image of at least a part of the reading material. No further functional elements should therefore be arranged between the image-recording device, in the form of, for example, a camera, and the platen. A “clear view” of the platen is desirable for the camera. In specific terms, the image-recording device can, for example, be assigned in such a way to the support element or coupled in such a way to the support element that the image-recording device pivots together with the support element when the support element is pivoted relative to the platen. In a further advantageous manner and in order to realize a particularly compact design of the reading device, the image-recording device could be integrated into the pivot axis of the support element.

In the operating position of the reading device, in which the platen and the support element are pivoted and inclined relative to each other in a suitable manner, lateral extraneous light can be incident on the image-recording device thereby impairing a reliable acquisition of a text and/or an image of the reading material. In order to prevent or reduce such an incidence of extraneous light, the reading device can have at least one screening element, preferably a flap, which can be of a triangular design and/or can be folded out of or away from the base element or support element. This allows the lateral areas or side openings of the arrangement of platen and support element in the operating position to be at least partially closed, so that an incidence of lateral extraneous light can be prevented or at least reduced.

In a specific embodiment, the at least one screening element can be assigned to the base element or to the support element, wherein preferably the at least one screening element can be pivotally mounted on the base element or support element. In a further advantageous manner, two screening elements are provided which can be arranged on both sides of the arrangement of platen and support element in the operating position.

A base element as described above can be designed specifically in the form of a tray into which the support element and the platen can be pivoted when in the transportation or rest position. Screening elements mounted pivotably on, for example, the base element or the tray can be folded out of such a tray and serve to create an essentially closed body consisting of screening elements, platen, support element and optionally the base element. In this case, a particularly reliable acquisition of a text and/or an image by way of the image-recording device is ensured.

The reading device according to the present disclosure offers numerous advantages. A camera-based image-recording device ensures a very fast acquisition of a text and/or an image of a reading material. The arrangement of the reading material on the platen, which preferably takes the form of a glass plate, provides a well-defined environment for the image acquisition. In a further advantageous manner, an illumination device for illuminating the reading material can be assigned to the platen. A flat design of the platen ensures a secure positioning of the reading material to be acquired. The upper edge created by the inclined positioning of the platen serves in a particularly advantageous manner for the acquisition and reading of the reading material up to, for example, a fold in books or magazines. The collapsibility of the reading device due to the pivotability of the platen and the support element relative to each other means that the reading device can be brought into a very small and portable arrangement. The reading device, in particular the image-recording device and/or a processing device and/or a display device and/or a speech output device, can be operated by way of a rechargeable battery independently of mains power. Such a rechargeable battery can be integrated, for example, into the image-recording device or into the processing device. A processing device which is suitably assigned to the reading device or integrated into the reading device ensures integrated character recognition and preferably speech output. A display device in the form of a screen, for example, can optionally be assigned to the reading device or integrated into the reading device.

### BRIEF DESCRIPTION OF THE SEVERAL VIEWS OF THE DRAWINGS

There are various options for advantageously designing and developing the teaching of the present disclosure. In this regard, with the aid of the drawings reference is made, on the one hand, to the subordinate claims and, on the other hand, to the following explanation of preferred exemplary embodiments of the disclosure. In connection with the explanation of the preferred exemplary embodiments of the disclosure, generally preferred designs and developments of the teaching are also explained with reference to the drawings. The drawings show the following:

FIG. 1 in a schematic and perspective view, a first exemplary embodiment of the reading device according to the disclosure,

FIG. 2 in a schematic and perspective view, the reading device from FIG. 1 in the closed state,

FIG. 3 in a schematic and perspective view, a second exemplary embodiment of the reading device according to the disclosure in an operating position and in a closed transportation or rest position,

FIG. 4 in a schematic and perspective view, a third exemplary embodiment of the reading device according to the disclosure in an operating position and in a closed transportation or rest position,

FIG. 5 in a schematic and perspective view, a fourth exemplary embodiment of the reading device according to the disclosure in an operating position,

FIG. 6 in a schematic and perspective view, a fifth exemplary embodiment of the reading device according to the disclosure in an operating position, and

FIG. 7 in a schematic and perspective view, the reading device from FIG. 6 in the closed transportation or rest position.

### DETAILED DESCRIPTION

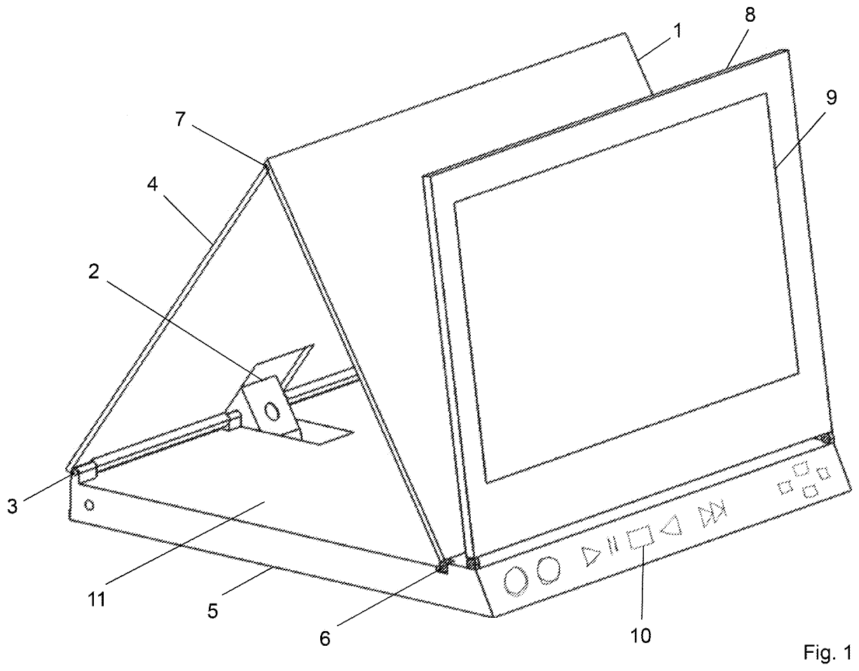

FIG. 1 shows, in a schematic and perspective view, a first exemplary embodiment of reading device according to the present disclosure with a flat and transparent platen 1 in the form of a glass plate for an item of reading material, and an image-receiving device 2 in the form of a camera for acquiring through the platen 1 a text and/or an image of at least a part of the reading material. With regard to a particularly simple transportation and a simple stowage of the reading device when the reading device is not in use, a support element 4 which can be pivoted relative to the platen 1 about a pivot axis 3 is assigned to the platen 1. Specifically, the support element 4 is pivotably mounted via the pivot axis 3 on a base element 5 which serves as an installation base or standing aid for positioning on a substrate. The platen 1 is likewise pivotably mounted on the base element 5 via a pivot axis 6 so that the platen 1 and the support element 4 can be pivoted independently of each other relative to the base element and relative to each other.

The support element 4 can be pivoted into an operating position, shown in FIG. 1, that is inclined at a definable angle to a vertical direction for the purpose of positioning the platen 1. The vertical direction corresponds to the perpendicular direction and is perpendicular to the earth's surface. Both the pivot axis 3 and the pivot axis 6 are realized on the base element 5. The platen 1 has a contact area in the form of a groove 7 for the support element 4 so that, in the operating position, the support element 4 is arranged with its upper edge in the groove 7.

The image-recording device 2 is coupled to the support element 4 so that a pivoting of the support element 4 also results in a pivoting of the image-recording device 2. In the operating position shown in FIG. 1, the image-recording device 2 with its camera points toward the platen 1 on which reading material to be acquired can be positioned. The prism-like shape of the reading device, when in the operating position, ensures a flat placement of the reading material, for example, a book or a periodical, on the platen 1 up to being into a marginal or fold area of the reading material so that a reliable acquisition of the complete text and/or image of the reading material is made possible.

The platen 1 is assigned a flat cover 8 which is likewise pivotably mounted on the base element 5. The cover can be used for holding or placing the reading material against the platen 1. Furthermore, a display device 9 in the form of a screen for displaying the acquired text and/or image is integrated in the cover 8. Instead of the cover 8, a display device 9, which can be mounted on the base element 5, can be also exclusively provided.

Control elements 10 for the reading device are realized on the front side of the base element 5.

The reading device further comprises a processing device 11 for processing the text and/or image acquired by way of the image-recording device 2. In the exemplary embodiment shown here, the processing device 11 is integrated in the base element 5.

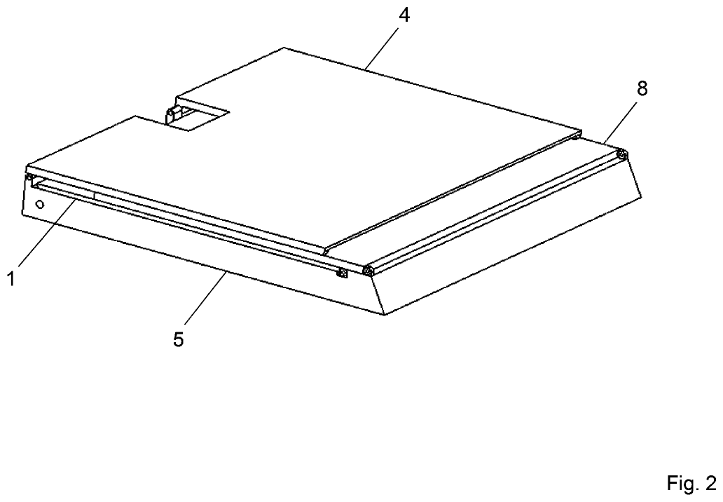

FIG. 2 shows the exemplary embodiment from FIG. 1 in a closed transportation or rest position, wherein the platen 1 and the support element 4 substantially—with the cover 8 between them—lie against or upon each other. Depending on the embodiment, the platen 1 and the support element 4 can, in the transportation or rest position, lie in direct contact with one another or have an element interposed between them. In this transportation or rest position, a handy arrangement is realized which can be transported in a simple manner, for example, put into a bag or held only with one hand.

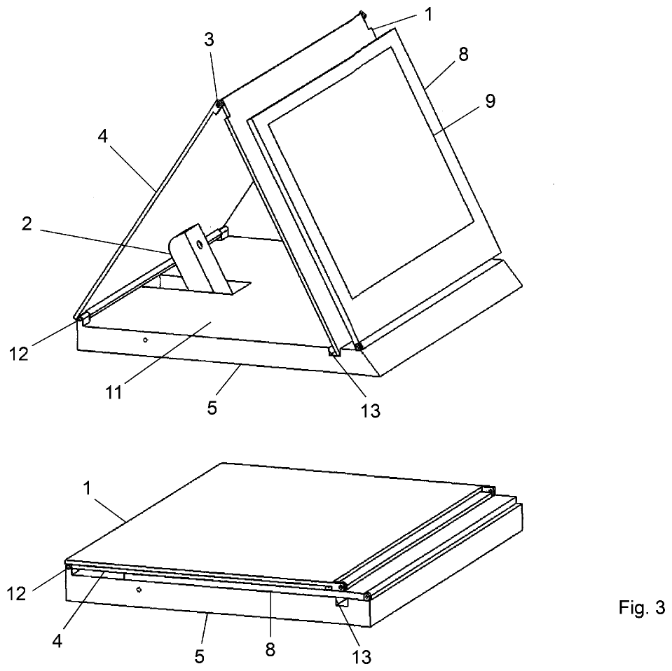

FIG. 3 shows, in two schematic and perspective views, a second exemplary embodiment of the reading device according to the disclosure in an operating position and in a transportation or rest position. In this exemplary embodiment, the platen 1 can be pivoted relative to the support element 4 via a pivot axis 3 which is realized in an edge region of the platen 1. In this embodiment, the platen 1 and the support element 4 are directly coupled to one another via the pivot axis 3. The support element 4 is pivotably mounted on the base element 5 via a further pivot axis 12 on the side facing away from the platen 1.

In the operating position, the platen 1 is supported in a groove 13 formed in the base element 5. The processing device 11 is likewise arranged in the base element 5 in this exemplary embodiment. In the transportation or rest position shown in FIG. 3 (below), the cover 8 is first placed on the base element 5, and the support element 4 and the platen 1—pivoted away from the base element 5—are placed on the cover 8 in the closed state.

In an exemplary embodiment (not shown here), instead of the support element 4 the platen 1 can be mounted pivotably on the base element 5, wherein in this case the support element 4 can be supported in a groove formed in the base element 5 in order to provide the prism-like operating position.

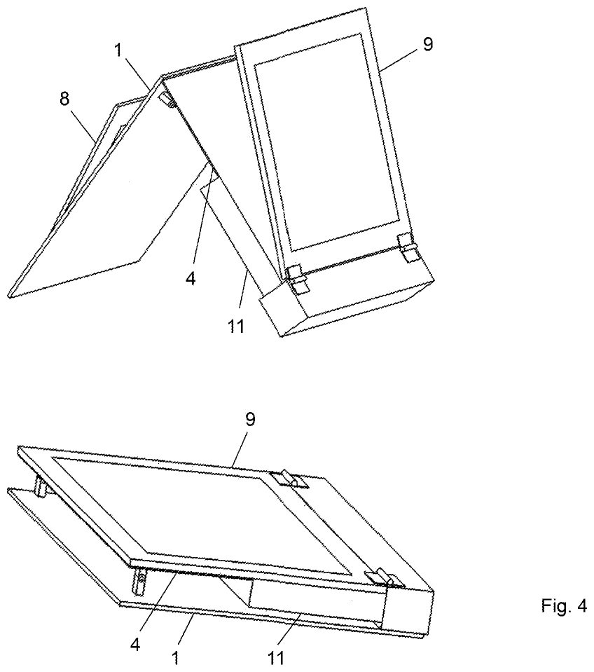

FIG. 4 shows a third exemplary embodiment of the reading device according to the present disclosure in two schematic and perspective views. In this exemplary embodiment, no base element is provided, and the platen 1 and the support element 4 are mounted pivotably directly on one another. A cover 8 that is pivotable relative to the platen 1 is assigned to the platen 1. Furthermore, a display device 9 is pivotably mounted on the support element 4. Furthermore, a processing device 11 for processing the text and/or image acquired by means of the image-recording device 2 is assigned to the support element 4. The image-recording device 2 is not shown in FIG. 4 and is essentially assigned to the processing device 11 or integrated therein. In the lower part of FIG. 4, the third exemplary embodiment is shown in a transportation or rest position.

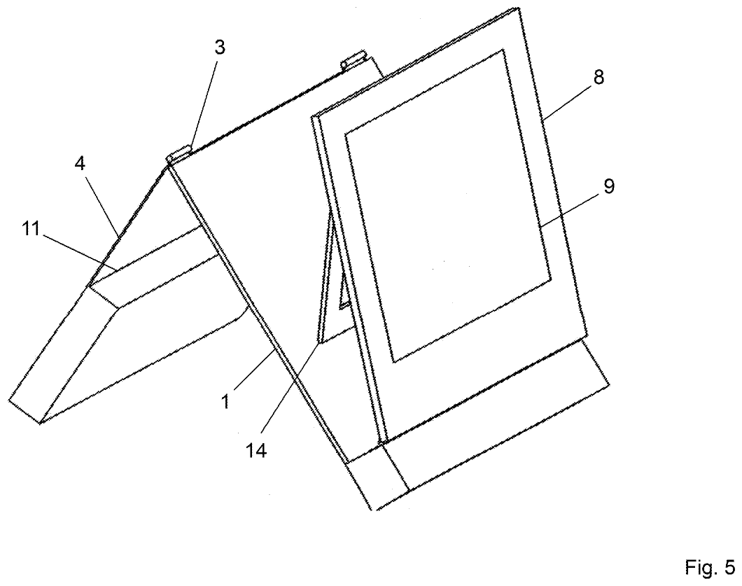

FIG. 5 shows, in a schematic and perspective view, a fourth exemplary embodiment of the reading device according to the disclosure in its operating position. Like the third exemplary embodiment shown in FIG. 4, the fourth exemplary embodiment shown in FIG. 5 does not have a base element. The platen 1 is mounted relative to the support element 4 via a pivot axis 3. The support element 4 is assigned a processing device 11 with an integrated image-recording device 2, not shown here. A cover 8 with an integrated display device 9 is mounted on the platen 1 pivotally with respect to the platen 1. The cover 8 or the display device 9 is assigned a prop 14 which is mounted pivotably on the cover 8 or on the display device 9. This enables the inclination of the display device 9 during operation of the reading device to be preset, wherein the prop 14 can be supported on the platen 1.

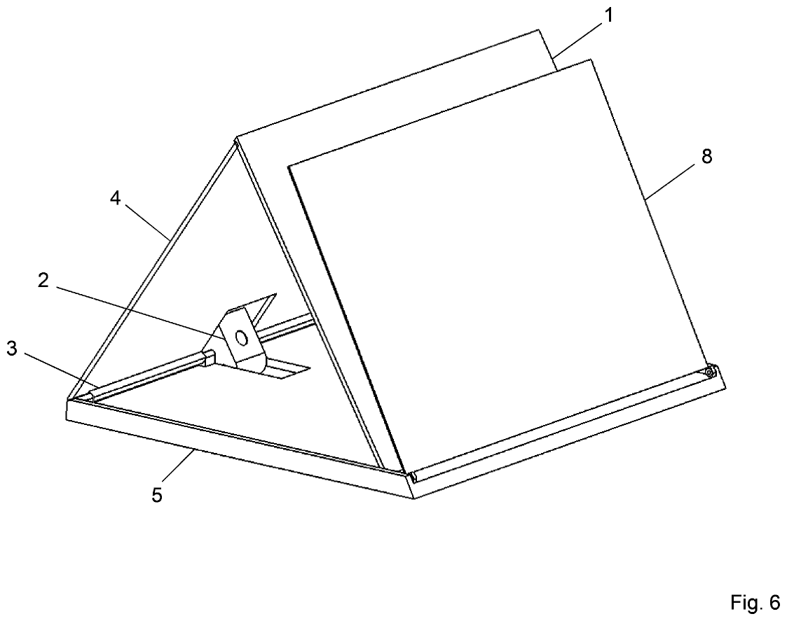

FIG. 6 shows a fifth exemplary embodiment of the reading device according to the present disclosure, wherein this exemplary embodiment has a platen 1, a support element 4, and a base element 5 taking the form of a tray. Both the platen 1 and the support element 4 are pivotally mounted on the base element 5. The support element 4 is mounted on the base element 5 via a pivot axis 3, and the platen 1 is mounted on the base element 5 via a further pivot axis, not shown here. The cover 8 is also pivotably mounted on the base element 5. In an alternative embodiment not shown here, the platen 1 as in the second exemplary embodiment shown in FIG. 3 could be mounted pivotably on the support element 4 instead of on the base element 5, wherein the support element 4 is further pivotably mounted on the base element 5. In a further alternative embodiment, the platen 1 could be mounted pivotably on the base element 5 and the support element 4 on the platen 1 and not on the base element 5.

In this exemplary embodiment which is shown in FIG. 6 and in the embodiments mentioned in the last paragraph as alternatives to this exemplary embodiment, it is essential that this reading device has no processing device but only an interface for connecting such a processing device and/or a display device and/or a speech output device. The reading device in accordance with the exemplary embodiment in FIG. 6 and with the corresponding alternative embodiments mentioned in the last paragraph and not shown in this case consists essentially only of the platen 1, the support element 4, the base element 5, the image-recording device 2, and a suitable interface, wherein even the base element 5 is not absolutely necessary and, in the context of a further exemplary embodiment with a pivotable mounting of the platen 1 directly on the support element 4, can be omitted. The image-recording device 2 can be supplied with power via this interface. A processing device for processing the text and/or image acquired by way of the image-recording device 2 can be connected via an interface taking the form of, for example, a USB connection. As a result, a mobile image-recording unit is provided, which can be transported in a simple manner to desired places of use. Since this exemplary embodiment does not have a processing device, display device, or speech output device, it is particularly light and mobile. It is also conceivable for the image-recording device 2 to be assigned a permanently built-in or removable storage device in order to store acquired text and/or an acquired image of reading material, for example, for later processing.

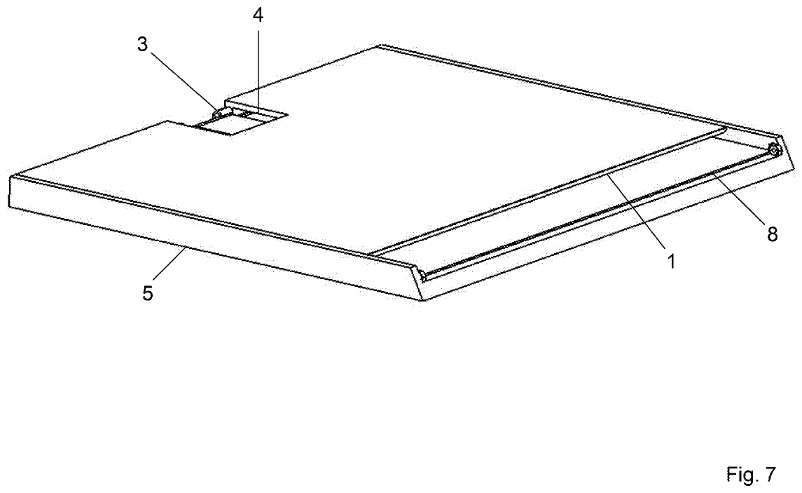

FIG. 7 shows the exemplary embodiment from FIG. 6 in a schematic and perspective view in its transportation or rest position. In this view, the platen 1, the support element 4, and the cover 8 are pivoted in a protected manner into the base element 5 that takes the form of a tray. In this case, the platen 1 rests on the support element 4 and the support element 4 on the cover 8.

With regard to other advantageous embodiments of the reading device according to the present disclosure, in order to avoid repetition, reference is made to the general part of the description and also to the appended claims.

Finally, it is expressly pointed out that the exemplary embodiments of the reading device according to the disclosure that are described above serve only to explain the claimed teaching, but do not restrict this to the exemplary embodiments.

### LIST OF REFERENCE NUMBERS

1 Platen
2 Image-recording device
3 Pivot axis
4 Support element
5 Base element
6 Pivot axis
7 Groove
8 Cover
9 Display device
10 Control element
11 Processing device
12 Pivot axis
13 Groove
14 Prop

The various embodiments described above can be combined to provide yet further embodiments. The foreign patent publication referred to in this specification is incorporated herein by reference. Aspects of the embodiments can be modified, if necessary to employ concepts of the publication to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A reading device, comprising:
a flat and transparent platen for reading material,
an image-recording device for acquiring through the platen a text and/or an image of at least one portion of the reading material, and
a support element that is pivotable relative to the platen about a pivot axis is assigned to the platen,
wherein the support element is pivotable into an operating position inclined at a defined angle to a vertical direction to position the platen, and
wherein the support element is also pivotable into a transportation or rest position whereby the platen and the support element substantially lie against each other.

2. The reading device according to claim 1, wherein the pivot axis is implemented in or at an edge region of the platen.

3. The reading device according to claim 1, wherein the support element or the platen is articulated pivotably on a base element.

4. The reading device according to claim 1, wherein the pivot axis is realized in or on a base element.

5. The reading device according to claim 4, wherein the platen is pivotably mounted on the base element.

6. The reading device according to claim 4, wherein the platen has a contact region for the support element.

7. The reading device according to claim 1, wherein the platen is assigned a flat cover.

8. The reading device according to claim 7, wherein the cover is pivotable relative to the platen.

9. The reading device according to claim 1, wherein the reading device has a processing device configured to process the text and/or image acquired by way of the image-recording device.

10. The reading device according to claim 9, wherein the reading device further comprises a display device configured to display the text and/or image processed by way of the processing device.

11. The reading device according to claim 9, wherein the reading device has a speech output device for audio output of the text and/or image processed by way of the processing device.

12. The reading device according to claim 1, wherein the image-recording device has an interface for connecting a processing device for processing the text and/or image acquired by the image-recording device and/or a display device for displaying the text and/or image processed by the processing device and/or a speech output device for audio output of the text and/or image processed by the processing device and/or a refreshable Braille display for outputting as Braille the text and/or image processed by the processing device.

13. The reading device according to claim 1, wherein the image-recording device is assigned to the support element, a base element, or a processing device, or is coupled to the support element, the base element, or the processing device.

14. The reading device according to claim 1, wherein the reading device has at least one screening element to prevent or reduce an incidence of extraneous light.

15. The reading device according to claim 14, wherein the at least one screening element is assigned to a base element or the support element.

16. The reading device according to claim 6, wherein the contact region has a groove or a projection.

17. The reading device according to claim 10, wherein the display device is realized as a common component with a cover.

18. The reading device according to claim 9, wherein the reading device has a refreshable Braille display for outputting in Braille the text and/or image processed by way of the processing device.

19. The reading device according to claim 14, wherein the at least one screening element is a flap that prevents or reduces an incidence of extraneous light.

20. The reading device according to claim 15, wherein the at least one screening element is mounted pivotably on the base element or the support element.
